(19) United States
(12) Patent Application Publication
(10) Pub. No.: US 2012/0235968 A1
(43) Pub. Date: Sep. 20, 2012

(54) METHOD AND APPARATUS FOR LINE TIME REDUCTION

(75) Inventors: Mark M. Todorovich, San Diego, CA (US); Wilhelmus Johannes Robertus Van Lier, San Diego, CA (US); Koorosh Aflatooni, Cupertino, CA (US)

(73) Assignee: QUALCOMM MEMS Technologies, Inc., San Diego, CA (US)

(21) Appl. No.: 13/291,474

(22) Filed: Nov. 8, 2011

Related U.S. Application Data
(60) Provisional application No. 61/453,032, filed on Mar. 15, 2011.

(51) Int. Cl. G09G 5/00

(52) U.S. Cl. 345/208

(57) ABSTRACT

This disclosure provides systems, methods and apparatus, including computer programs encoded on computer storage media, for reducing common line write time in a display. In one aspect, a common line write waveform shape is based at least in part on the distance a given common line is from a segment driver circuit.

### CROSS REFERENCE TO RELATED APPLICATIONS

This application claims priority under 35 U.S.C. Section 119(e) to U.S. Provisional Application No. 61/453,032, filed on Mar. 15, 2011.

### TECHNICAL FIELD

This disclosure relates to systems and methods for writing data to a display apparatus.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method of updating a display. The display includes a plurality of display elements arranged in common lines and segment lines, and the display elements in a respective common line are updated by providing data to each of the segment lines and by applying a waveform within a write window to the respective common line. The method may include generating a waveform within a write window associated with a particular common line, wherein the shape of the waveform is based, at least in part, on a position of the particular common line in relation to a segment driver circuit. The method may continue by applying the waveform to the particular common line. The shape of the waveform within the write window may include a front porch having a first duration, an address pulse having a second duration, and a back porch having a third duration. The sum of the first, second, and third durations may be constant for all common lines of the display. The sum of the first, second, and third durations may be different for at least some common lines of the display.

In another aspect, a display apparatus may include a set of segment lines, a segment line driver circuit configured to apply data signals to the set of segment lines during a series of write windows, a set of common lines, at least some of which have different distances from the segment line driver circuit, and a common line driver circuit configured to sequentially apply a write waveform to different ones of the set of common lines during different ones of the series of write windows. The common line driver circuit may be configured to apply a write waveform of a particular shape to a common line of the set of common lines, and the shape may be based at least in part on the position of the common line with respect to the segment driver circuit. The common line driver circuit may be configured to position an addressing pulse within the write window depending on the position of the common line with respect to the segment driver circuit.

In another aspect, a display apparatus may include a set of segment lines, a segment driver configured to apply data signals to the set of segment lines during a series of write windows, a set of common lines, at least some of which have different distances from the segment line driver circuit, and means for applying a write waveform of a particular shape to a common line of the set of common lines during one of the series of write windows, wherein the shape is based at least in part on the position of the common line with respect to the segment driver circuit.

In another aspect, a computer readable medium has stored thereon instructions that, when executed by processing circuitry, cause a display driver circuit to generate a waveform within a write window associated with a particular common line, wherein the shape of the waveform is based, at least in part, on a position of the particular common line in relation to a segment driver circuit, and apply the waveform to the particular common line.

Another innovative aspect may also be implemented in a method of updating a display. The display includes a plurality of display elements arranged in common lines and segment lines. The display elements in a particular common line are updated by providing data to each of the segment lines and by applying a waveform within a write window to the particular common line. The method may include generating a waveform within a write window associated with a particular common line, wherein the shape of the waveform is based, at least in part, on a signal travel time between a segment driver circuit and the particular common line. The method may continue by applying the waveform to the particular common line. The shape of the waveform within the write window may include a front porch having a first duration, an address pulse having a second duration, and a back porch having a third duration. The first duration may increase with increasing distance between the common line and the segment driver. The third duration may decrease with increasing distance between the common line and the segment driver circuit.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 is an example system block diagram illustrating an implementation of portions of a display system.

FIG. 10 is an illustration of an example implementation of common and segment waveforms used in a display system.

FIG. 11 is an illustration of timing properties for different common line waveform timing parameters in an example display system.

FIG. 12 is another illustration of timing properties for different common line waveform timing parameters in an example display system.

FIG. 13A illustrates an example write window that is long enough to include the maximum front porch and back porch parameters for all common lines of a display array.

FIGS. 13B-13C is an illustration of an example of varying positions of a write enabling pulse on a common line during a line time when writing to a display.

FIG. 14 is a flow chart of an example implementation of address pulse modification as a function of common line position.

FIGS. 15A and 15B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The subject matter described in this disclosure relates to changing the shape of a write waveform applied to common lines of a display apparatus during a frame write process. In particular, the shape of the waveform within a given line time is modified depending on the position of the common line being written with respect to a segment driver circuit.

Particular implementations of the subject matter described in this disclosure can be implemented to realize a reduction in line time when writing lines to a display array. This reduces the time for writing a frame, allowing for faster display updates when displaying full motion video and in other situations where a fast change in display content is desirable. For example, slow frame rates suffer from motion artifacts such as tilting and rubberbanding. A vertical line moving to the right will appear to tilt to the right like “I” while a vertical line moving to the left will appear like “\”. Text scrolling down will appear to be compressed; text scrolling up will appear stretched. This is the result of the time difference between when the top line is updated and when the bottom line is updated. As the eye integrates these updates, the time delay is interpreted as the described motion artifact. Faster frame rate reduces time difference between top and bottom, and reduces these artifacts.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

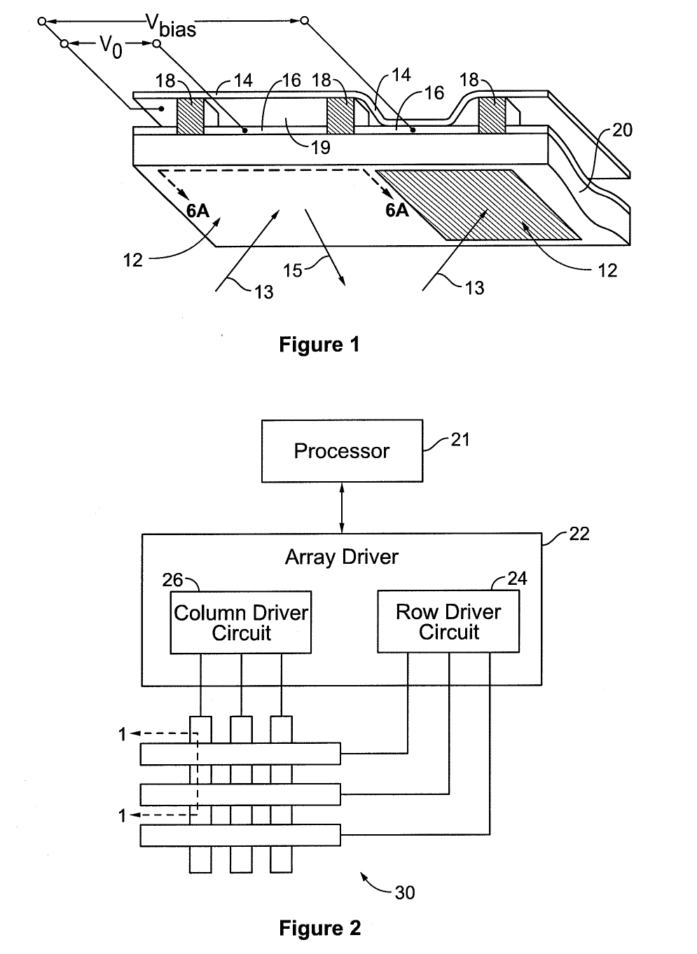

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

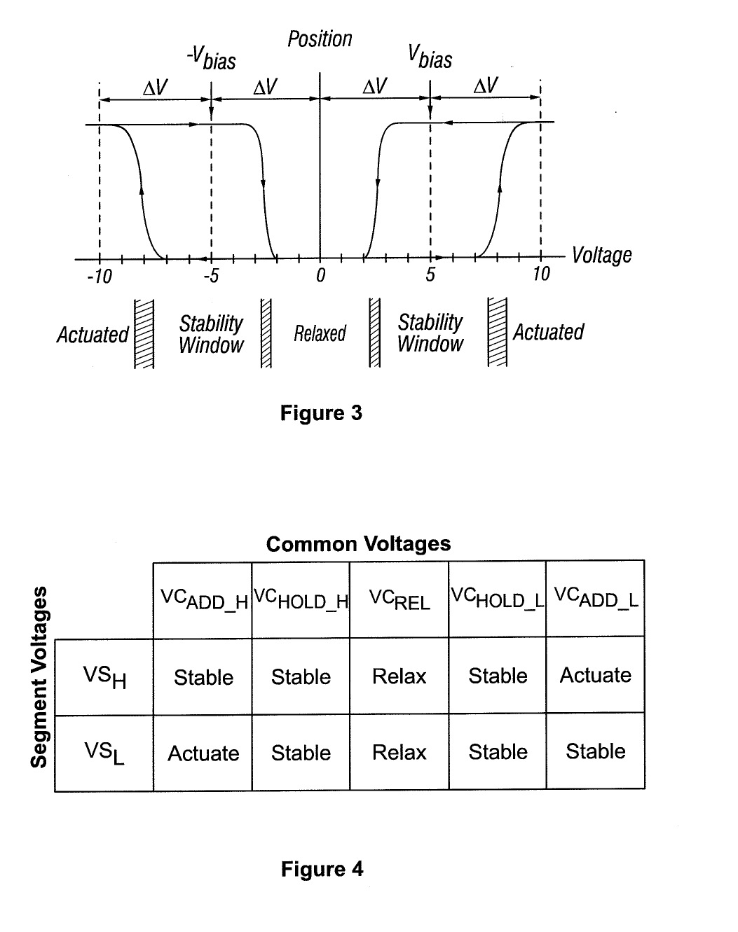

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

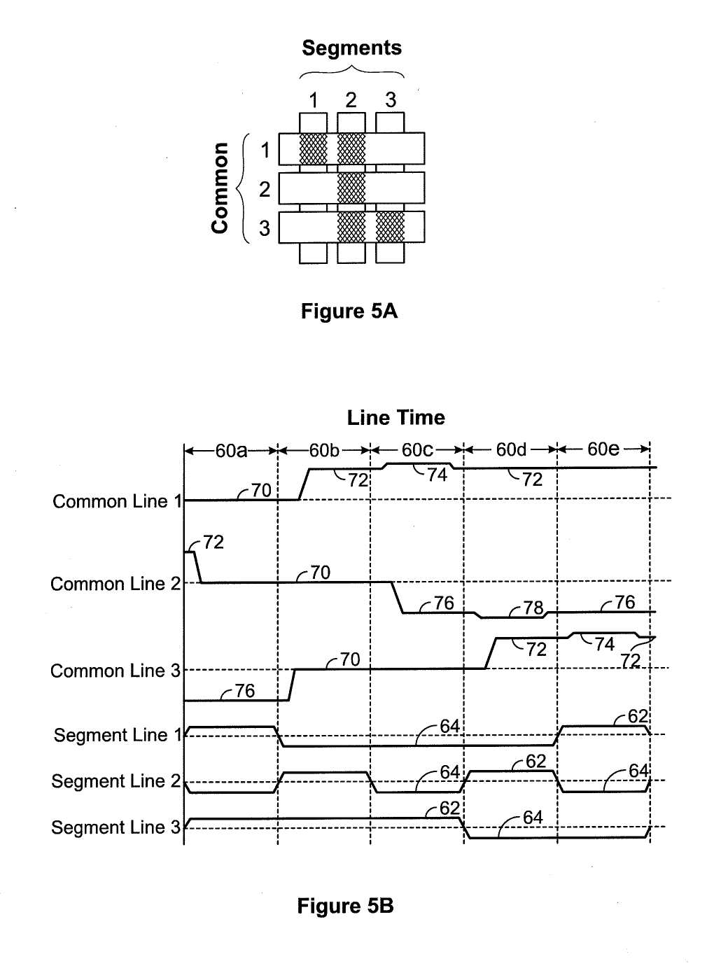

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

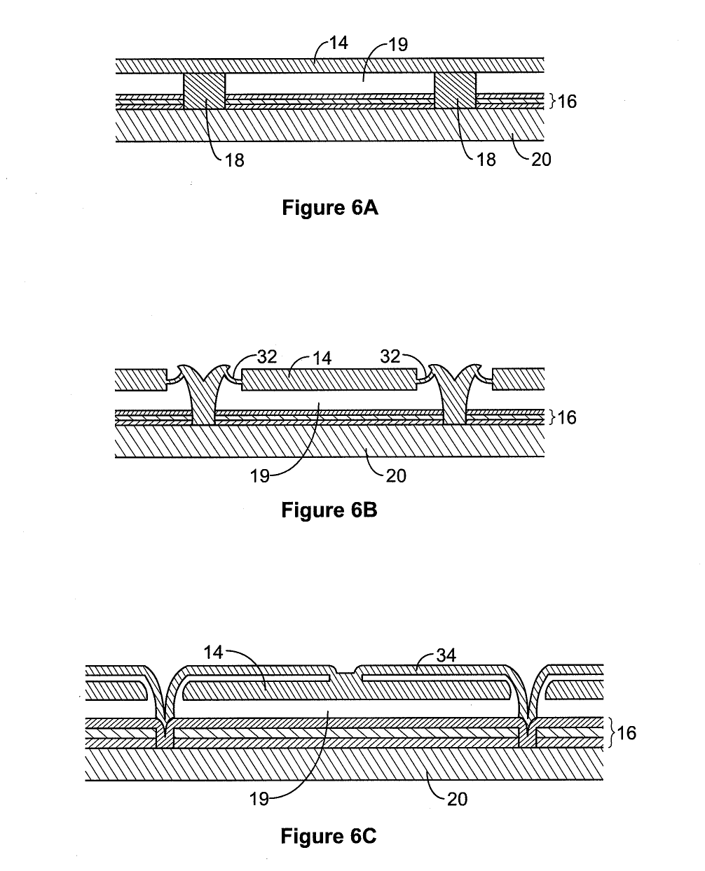

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

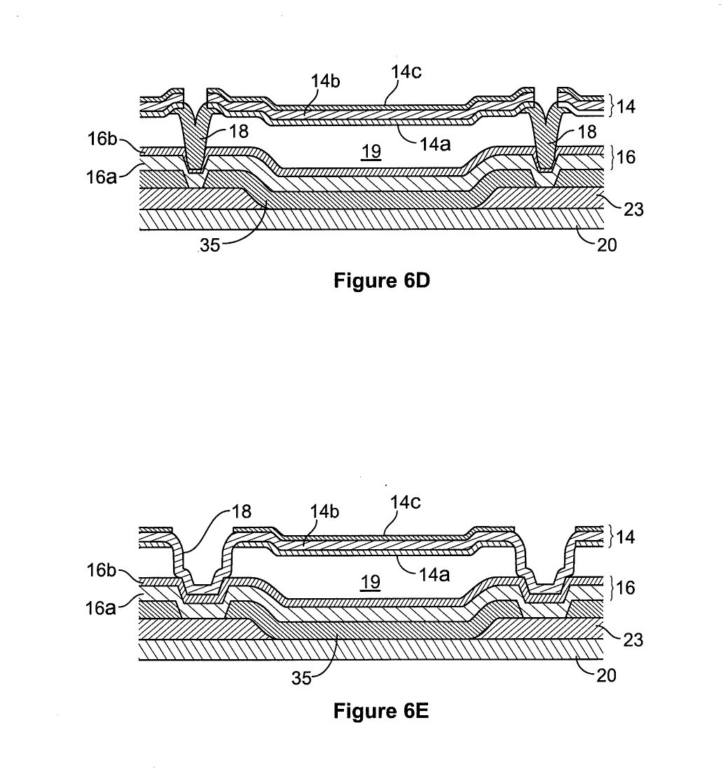

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}^{H} or a low hold voltage VC_{HOLD}_{_{—}}^{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}^{H} or a low addressing voltage VC_{ADD}_{_{—}}^{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}^{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}^{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}^{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

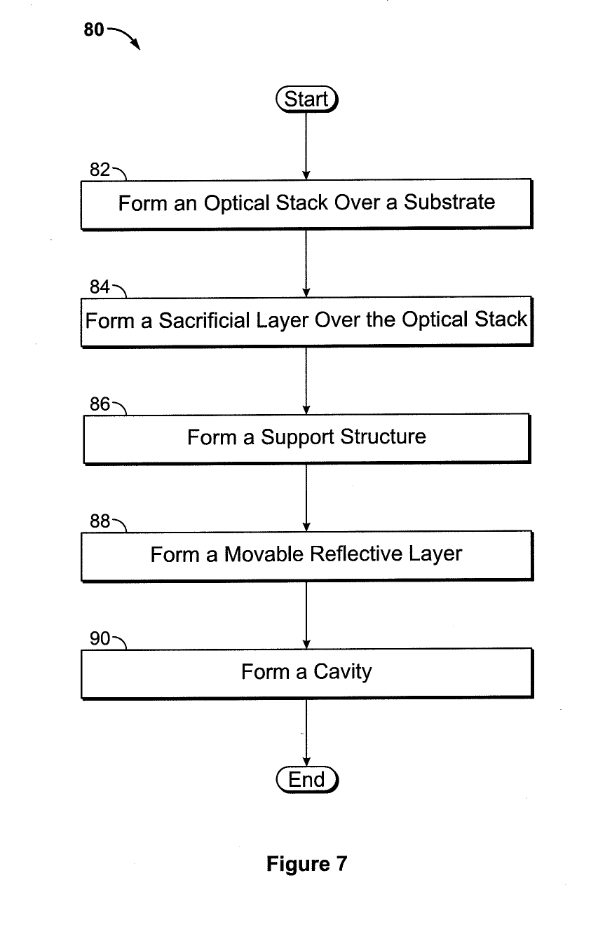

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

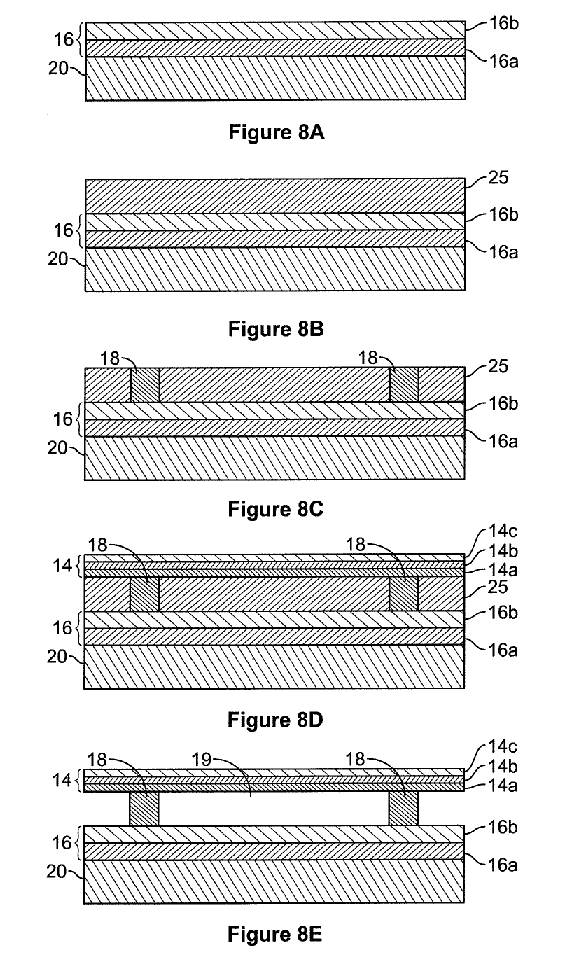

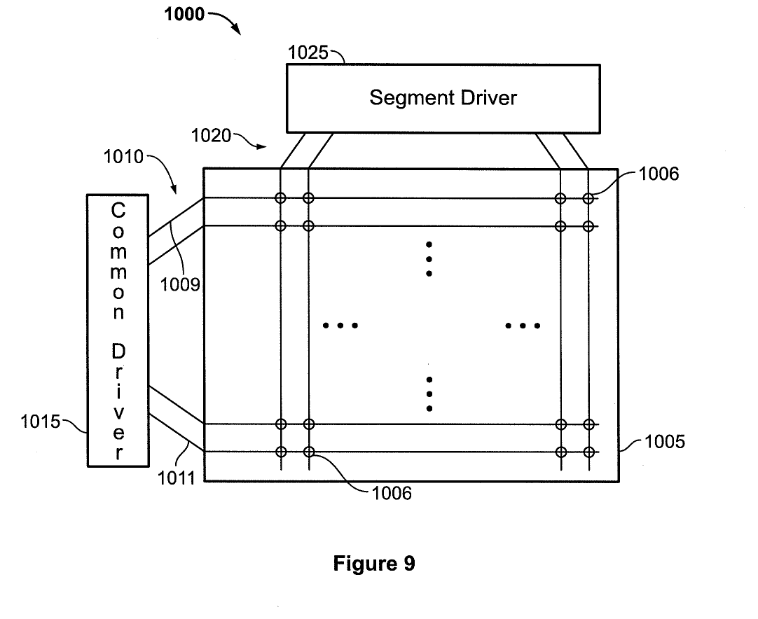

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Some of the implementations disclosed herein relate to an apparatus and methods for updating a display, including passive matrix IMOD displays such as those described above and other passive matrix displays. In one particular implementation, an apparatus for reducing line time is provided. As described herein, in one aspect, a line of display elements in a display may by updated by supplying display data to a plurality of segment lines from a segment driver during a write window. During the write window, a write enabling waveform is also applied to a common line associated with the line of display elements by a common line driver. In general, the duration of the write window and the shape of the write enabling waveform may be selected in order to ensure correct operation of the display elements. For example, the duration of the write window and the shape of the write enabling waveform can be configured so that the segment and common line voltages overlap for sufficient time for the display elements to permit accurate operation. In some implementations, the length of the write window and the shape of the write enabling waveform may be uniform for each line of display elements in the display. However, as described herein, it may be advantageous to change the length of the write window and the shape of the write enabling waveform based on the position of the line in the display. By doing so, the line refresh time for the display may be reduced and the frame rate for the display may correspondingly increase. Implementations of a display system for reducing time line in this manner are described herein.

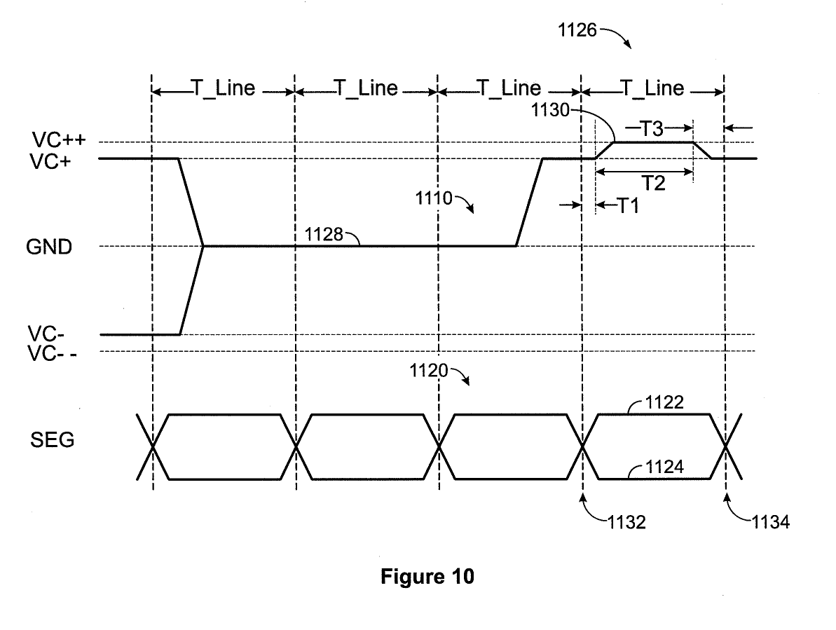

FIG. 9 is a block diagram illustrating an implementation of portions of a display system. The display 1000 may be similar to the displays described above with respect to FIGS. 2, 5, and 6. The display 1000 includes a display panel 1005, a plurality of display elements 1006, a plurality of common lines 1010, a common line driver 1015, a plurality of segment lines 1020, and a segment driver 1025. The display panel 1005 includes the plurality of display elements 1006. The display elements 1006 are arranged on the panel 1005 as a plurality of rows and columns. Each row of display elements 1006 corresponds to one of the plurality of common lines 1010. Similarly, each column of display elements 1006 corresponds to one of the plurality of segment lines 1020. The operation of the display elements is described in more detail above with respect to FIGS. 1 through 5. In general, during an update, voltage levels corresponding to a line of data to be displayed on the display 1000 are driven on to the plurality of segment lines 1020 by the segment line driver 1025. Once data has been driven onto the segment lines 1020, the common line driver 1015 drives a write enabling waveform onto a selected one of the common lines 1010, for example, the common line 1009. In this manner, the display elements 1006 in the row corresponding to the common line 1009 are manipulated or updated according to the data on the segment lines 1020. In particular, the combination of the write enabling waveform on the common line 1009 and the display data on the segment lines 1020 cause the individual display elements 1006 in the row corresponding to common line 1009 to actuate as described with respect to FIG. 5B. At the same time, the display elements 1006 in other rows are unaffected. New data is then driven onto the segment lines 1020 by the segment line driver 1025, and a write enabling wave form may be driven on to a different common line. In this manner, the entire display panel 1005 may be updated row by row.

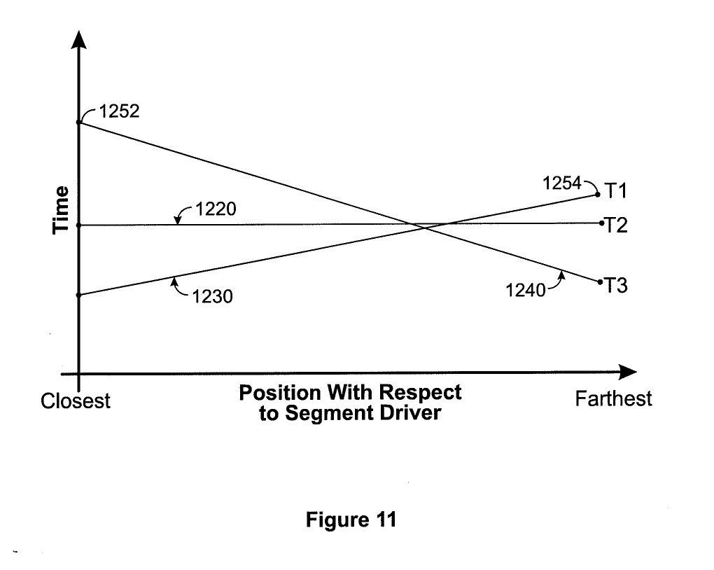

FIG. 10 is an illustration of an implementation of common and segment waveforms used in a display system. In FIG. 10, a common line waveform 1110 is illustrated such as is also shown and described above with reference to FIG. 5B. The segment voltage waveforms are also illustrated at 1120, where either a high segment voltage 1122 or a low segment voltage 1124 is applied to each segment line. As described above, the common line to which the waveform 1110 is applied will have image data written to it during a line time 1126. Along the common line that receives the voltage waveform illustrated at 1110, display elements that receive a low segment voltage 1124 will actuate during the line time 1126 when the address voltage 1130 of the waveform is applied, while display elements that receive a high segment voltage 1122 will remain in the released state they were put in during the earlier release phase 1128 of the common line waveform 1110.

In order to ensure proper operation of the display 1000, the relative timing of the display data signals on the segment lines 1020 and the write enabling waveform on the common lines 1010 may be precisely controlled. For example, the driver controller is configured to make the duration of the address voltage 1130 long enough to ensure that the display elements 1006 actuate as intended during this period. This is the period T2 of FIG. 10. In addition, the driver controller 29 may be configured to ensure that data signals on the segment lines 1020 are stable at their intended values following the data transition at the start of the line time (denoted 1132) before the address voltage 1130 is applied. This is the time period T1 illustrated in FIG. 10 and may be referred to as the “front porch” of the write waveform. Furthermore, the driver controller may be configured to ensure that the addressing voltage 1130 settles back to the hold voltage level before the end of the line time (denoted 1134). This is the time period T3 illustrated in FIG. 10, and may be referred to as the “back porch” of the write waveform.

Referring back to FIG. 9, it may be noted that different common lines 1010 are situated at different distances from the segment driver 1025. For example, common line 1009 is closer to the segment driver than common line 1011. This difference in distance from the segment driver results in different timing behavior of the segment voltages during segment voltage transitions at the lines of different distances. When the segment driver changes the state of a segment line, the change appears first at the common lines nearest the segment driver circuit. There is sufficient impedance along the segment line length that the rise time of the voltage is longer at the far end of the display away from the segment driver. Because of this, it can be useful for the front porch of the waveform of FIG. 10 (time T1) to be longer for common lines farther from the segment driver. In addition, because the segment transitions occur sooner for common lines closer to the segment driver, it can be useful for the back porch of the waveform of FIG. 10 (time T3) to be longer for common lines closer to the segment driver. The addressing time T2 can be independent of common line position with respect to the segment driver since during this period the segment voltages are settled and stable between line time transitions.

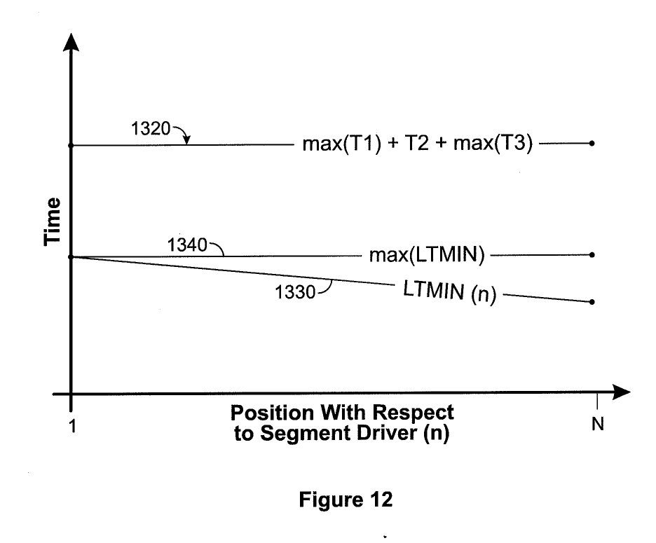

These relationships are illustrated in FIG. 11, where FIG. 11 is an illustration of timing properties for different common line waveform timing parameters in a display system. In this Figure, common lines closer to the segment driver are on the left. As shown in this Figure, the time for T2 (represented by line 1220) is constant across the array. The front porch T1 (represented by line 1230) is shown as increasing for common lines farther from the segment driver. The back porch T3 (represented by line 1240), is shown as decreasing for common lines farther from the segment driver.

Conventionally, the same front porch times and back porch times are used for every common line across the array. In such implementations, the front porch used for every common line is the overall maximum front porch (based on the farthest common line) shown as the value for T1 at point 1254 on FIG. 11. Furthermore, the back porch used for every common line is the overall maximum back porch (based on the closest common line) shown as the value for T3 at point 1252 on FIG. 11. The total line time used in these conventional implementations is therefore max(T1)+T2+max(T3). This results in line times that are unnecessarily long, however, because for a given common line, extra front porch, back porch, or both are being provided. This wasted line time can be removed if, for each common line, the shape of the common line write waveform within the write window is based, at least in part, on a position of the particular common line in the display with respect to the segment driver.

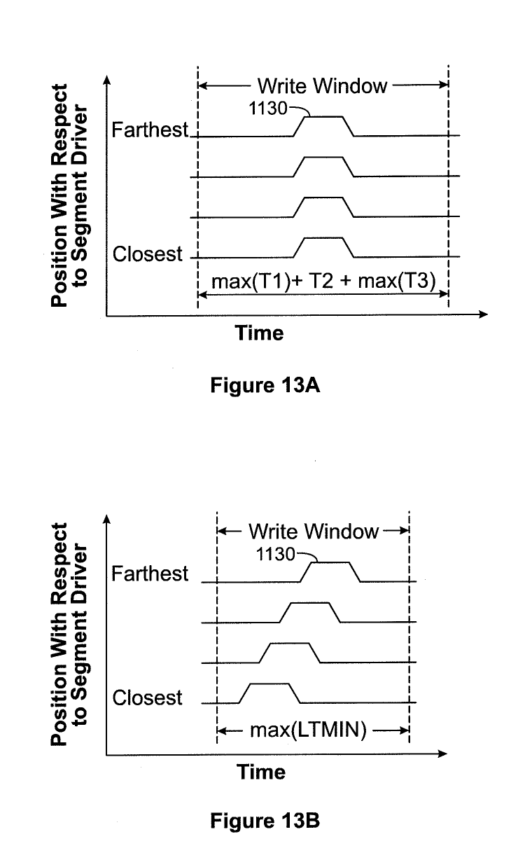

The potential line time reductions are illustrated in FIG. 12, where FIG. 12 is another illustration of timing properties for different common line waveform timing parameters in a display system. Referring now to FIG. 12, line 1320 illustrates the conventionally used line time of max(T1)+T2+max(T3). If the relationship between porch times and common line position is linear, as shown in FIG. 11, then the minimum front porch, back porch, and address times for the nth common line from the segment driver out of a total of N lines can be determined as set forth below:

(1) Minimum Front Porch=T1(n)=(1-n/N)* T1(1)+(n/N)*T1(N)

(2) Addressing Period=T2

(3) Minimum Back Porch=T3(n)=(1-n/N)*T3(1)+(n/N)*T3(N)

The minimum line time as a function of common line position with respect to the segment driver is the sum of these three values, and is denoted herein as LTMIN(n):

(4) LTMIN(n)=(1-n/N)(T3(1)+T1(1))+(n/N) (T3(N)+T1(N))+T2

This line time is a linear function of n, the common line position. This minimum line time as a function of n is represented in FIG. 12 as line 1330. This equation has a maximum value when n is at either the closest or farthest common line with respect to the segment driver (n=either 1 or N) and a minimum value at the other end (n=either N or 1). Which end is the maximum depends on the relative slopes of T1(n) and T3(n). This is represented as line 1340 of FIG. 12, and is denoted herein as max(LTMIN).

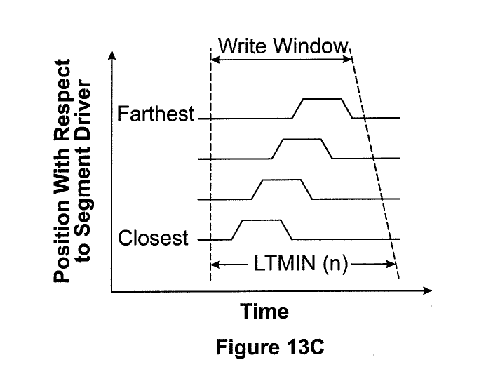

Reference will now be made to FIGS. 13A-13C. FIG. 13A illustrates a conventional write process where the write window is long enough to include the maximum front porch and back porch parameters for all common lines of a display array. As discussed above, the maximum front porch and maximum back porch are provided in every write window (also referred to as a line time). The address pulse is consistently positioned at the same location of the write window.

FIGS. 13B-13C illustrate varying positions of a write enabling pulse on a common line during a line time when writing to a display. Referring first to FIG. 13B, in these implementations, the front porch increases with distance from the segment driver, and the back porch decreases with distance from the segment driver. If the addressing voltage period T2 is shifted later in the write window as the common lines get farther away from the segment driver, a shorter write window as shown in FIG. 13B as compared to FIG. 13A can be used across all the common lines of the display array because some excess front porch and back porch times are eliminated. This increases the maximum frame rate that the display can exhibit. In the implementation of FIG. 13B, the maximum value of Equation 4 is used as the line time for all common lines, which is the value max(LTMIN) shown as line 1340 of FIG. 12.

In one implementation, the front porch, back porch, and addressing periods as a function of common line position may be defined as follows:

(5) Front Porch=T1(n)+½ (max(LTMIN)-T1(n)-T2-T3(n))

(6) Addressing Period=T2

(7) Back Porch=T3(n)+½ (max(LTMIN)-T1(n)-T2-T3(n))

Where T1(n) is as given above in Equation 1, and T3(n) is as given above in Equation 3. Therefore, given a value for n and given the front and back porch times at the closest and farthest common lines from the segment driver, the position of the address pulse in the write window may be defined. Equations 5, 6, and 7 sum to max(LTMIN) for all n, but the value of Equation 5 increases with increasing n, and the value of Equation 7 decreases with increasing n, producing the shifting address pulse within the write window illustrated in FIG. 13B.

The implementation of FIG. 13B uses a constant duration write window when writing all the common lines of the display array. Another implementation illustrated in FIG. 13C uses a write window that changes in duration as a function of common line distance from the segment driver. In this implementation, LTMIN(n), or something substantially close to this value, can be used as the write window for each common line n. The write widow durations are based on line 1330 of FIG. 12 as the common line being addressed moves farther from the segment driver. In this implementation, the front porch, back porch, and addressing periods as a function of common line position may be defined as follows:

(8) Front Porch=T1(n)

(9) Addressing Period=T2

(10) BackPorch=T3 (n)

Where T1(n) is as given above in Equation 1, and T3(n) is as given above in Equation 3. As with Equations 5 and 7 above, Equation 8 increases with increasing n, and Equation 10 decreases with increasing n. However, the sum of Equations 8, 9, and 10 is not constant over n, and thus the write window duration changes depending on the position of the common line being addressed. This allows additional reduction in frame write times because many of the common lines can be written to in a time period shorter than max(LTMIN).

In the description above, the front porch time T1 and the back porch time T3 are considered functions of n. It is also possible that T2 is a function of n, instead of being a constant as assumed above. In addition, although the times T1 and T3 are modeled as linear functions of n, the dependence on n of any or all of T1, T2, or T3 may be non-linear.

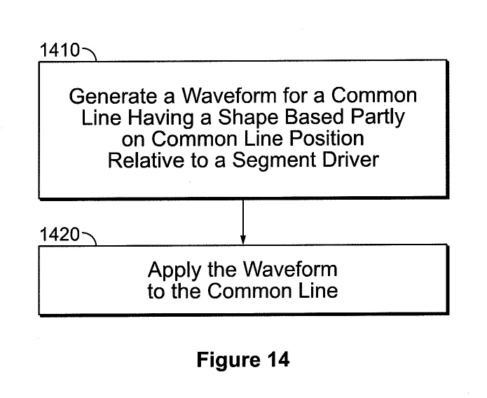

In general, implementations described herein use the principle of modifying the shape of an addressing pulse in a write window depending on the position of the common line the addressing pulse is applied to relative to a segment driver of the array. This position dependence is useful because for many arrays, the segment signal travel time to a particular common line will be dependent on the distance between the segment driver and the common line. It is possible in some cases for the signal travel time from the segment driver to a common line is dependent on some other physical characteristic of the array (such as common line orientation, segment line material or shape changes along the segment line, etc.). Therefore, in some aspects, the shape of the addressing pulse can be based at least in part on the signal travel time to the common line and/or on one or more physical characteristics of the array other than common line position or distance. The position dependent method is illustrated in FIG. 14, which is a flow chart of an implementation of address pulse modification as a function of common line position. In this implementation, at block 1410, a waveform is generated. The waveform may be generated for a particular write window. The shape of the waveform is based at least in part on the position of a common line with respect to a segment driver for the array. At block 1420, the particular waveform is applied to the common line in that position. Typically, generating and applying will occur at the same time, but this may not always be the case. As discussed above, the particular shape may include an addressing pulse that has a position within the write window that depends, at least in part, on the position of the common line with respect to the segment driver.

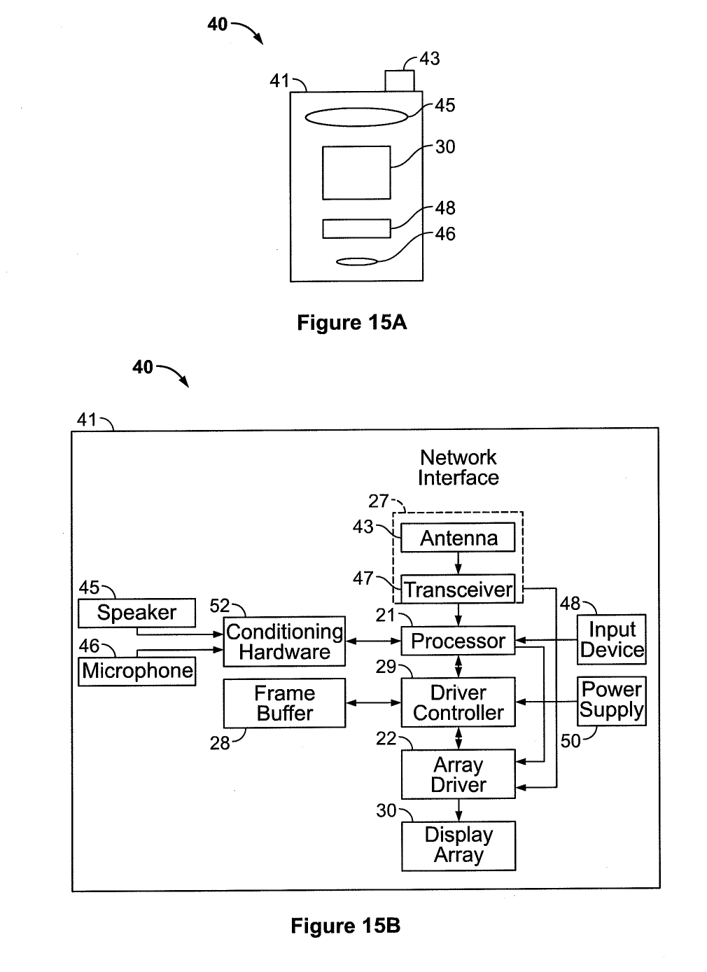

FIGS. 15A and 15B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 15B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing burden on the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of updating a display, the display comprising a plurality of display elements arranged in common lines and segment lines, wherein the display elements in a respective common line are updated by providing data to each of the segment lines and by applying a waveform within a write window to the respective common line, the method comprising:
generating a waveform within a write window associated with a particular common line, wherein the shape of the waveform is based, at least in part, on a position of the particular common line in relation to a segment driver circuit; and
applying the waveform to the particular common line.

2. The method of claim 1, wherein the shape of the waveform within the write window comprises:
a front porch having a first duration;
a address pulse having a second duration; and
a back porch having a third duration.

3. The method of claim 2, wherein the sum of the first, second, and third durations is constant for all common lines of the display.

4. The method of claim 2, wherein the first duration increases with common line distance from the segment driver, and wherein the third duration decreases with common line distance from the segment driver.

5. A display apparatus comprising:
a set of segment lines;
a segment line driver circuit configured to apply data signals to the set of segment lines during a series of write windows;
a set of common lines, at least some of which have different distances from the segment line driver circuit;
a common line driver circuit configured to sequentially apply a write waveform to different ones of the set of common lines during different ones of the series of write windows;
wherein the common line driver circuit is configured to apply a write waveform of a particular shape to a common line of the set of common lines, and wherein the shape is based at least in part on the position of the common line with respect to the segment driver circuit.

6. The display apparatus of claim 5, wherein the common line driver circuit is configured to position an addressing pulse within the write window depending on the position of the common line with respect to the segment driver circuit.

7. The display apparatus of claim 5, further comprising:
a processor that is configured to communicate with the display, the processor being configured to process image data; and
a memory device that is configured to communicate with the processor.

8. The display apparatus of claim 7, further comprising a controller configured to send at least a portion of the image data to the segment driver circuit and an image source module configured to send the image data to the processor.

9. The display apparatus of claim 8, wherein the image source module includes at least one of a receiver, transceiver, and transmitter.

10. The display apparatus of claim 6, further comprising an input device configured to receive input data and to communicate the input data to the processor.

11. A display apparatus comprising:
a set of segment lines;
a segment driver configured to apply data signals to the set of segment lines during a series of write windows;
a set of common lines, at least some of which have different distances from the segment line driver circuit;
means for applying a write waveform of a particular shape to a common line of the set of common lines during one of the series of write windows, wherein the shape is based at least in part on the position of the common line with respect to the segment driver circuit.

12. The display apparatus of claim 11, wherein the means for applying a write waveform includes means for shifting a common line addressing pulse within the series of write windows.

13. The display apparatus of claim 11, wherein the shape of the waveform within the write window comprises:
a front porch having a first duration;
an address pulse having a second duration; and
a back porch having a third duration.

14. The display apparatus of claim 13, wherein the second duration is constant for each common line of the display.

15. The display apparatus of claim 13, wherein the first duration increases with common line distance from the segment driver and wherein the third duration decreases with common line distance from the segment driver.

16. A computer readable medium having stored thereon instructions that, when executed by processing circuitry, cause a display driver circuit to:
generate a waveform within a write window associated with a particular common line, wherein the shape of the waveform is based, at least in part, on a position of the particular common line in relation to a segment driver circuit; and
apply the waveform to the particular common line.

17. The computer readable medium of claim 16, wherein the instructions, when executed by processing circuitry, cause the display driver circuit to position an address pulse within the write window.

18. The computer readable medium of claim 16, wherein the shape of the waveform within the write window comprises:
a front porch having a first duration;
a address pulse having a second duration; and
a back porch having a third duration.

19. The computer readable medium of claim 18, wherein the sum of the first, second, and third durations is different for at least some common lines of the display.

20. The computer readable medium of claim 18, wherein the second duration is constant for each common line of the display.

21. The computer readable medium of claim 18, wherein the first duration increases with common line distance from the segment driver.

22. The computer readable medium of claim 21, wherein the third duration decreases with common line distance from the segment driver.

23. A method of updating a display, the display comprising a plurality of display elements arranged in common lines and segment lines, wherein the display elements in a respective common line are updated by providing data to each of the segment lines and by applying a waveform within a write window to the respective common line, the method comprising:
generating a waveform within a write window associated with a particular common line, wherein the shape of the waveform is based, at least in part, on a signal travel time between a segment driver circuit and the particular common line; and
applying the waveform to the particular common line.

24. The method of claim 23, wherein the shape of the waveform within the write window comprises:
a front porch having a first duration;
a address pulse having a second duration; and
a back porch having a third duration.

25. The method of claim 24, wherein the sum of the first, second, and third durations is constant for all common lines of the display.

26. The method of claim 24, wherein the second duration is constant for each common line of the display.

27. The method of claim 24, wherein the first duration increases with common line distance from the segment driver.

28. The method of claim 24, wherein the third duration decreases with common line distance from the segment driver.
